(19) United States
(12) Patent Application Publication
(10) Pub. No.: US 2026/0348857 A1
(43) Pub. Date: Nov. 5, 2026

(54) Device for analyzing a sample by laser beam, comprising means for collecting information to be analyzed

(71) Applicant: FARIAUT INSTRUMENTS, ORLEANS (FR)

(72) Inventor: François FARIAUT, Saint Jean de la Ruelle (FR)

(21) Appl. No.: 19/140,069

(22) PCT Filed: Dec. 18, 2023
(86) PCT No.: PCT/EP2023/086493

§ 371 Date: Jun. 17, 2025

(30) Foreign Application Priority Data
Dec. 20, 2022 (FR) FR2213973

(51) Int. Cl. G01N 21/71

(52) U.S. Cl. CPC G01N 21/718; G01N 2201/021; G01N 2201/06113; G01N 2201/08

(57) ABSTRACT

A device for elementary analysis of a sample to be examined. The device includes a frame on which are mounted: a base for supporting a sample to be examined; a module for generating a laser beam for generating a plasma generating an optical emission, and a collector for collecting the optical emission. The collector includes an optical fiber having a free end defining an end portion, wherein the free end has a beveled cut defining the end section.

### CROSS-REFERENCE TO RELATED APPLICATIONS

This Application is a Section 371 National Stage Application of International Application No. PCT/EP2023/086493, filed Dec. 18, 2023, and published as WO 2024/133166 A1 on Jun. 27, 2024, not in English, which claims priority to and the benefit of French Patent Application No. 2213973, filed Dec. 20, 2022, the contents of which are incorporated herein by reference in their entireties.

### FIELD OF THE DISCLOSURE

The present invention relates to the field of high-resolution mapping and analysis of elements in solids.

More particularly, the invention relates, in particular but not exclusively, to a high-resolution analysis device for mapping elements in metallic solids.

The invention can in particular apply to the elemental analysis of hydrogen and oxygen by optical emission spectrometry on laser-produced plasma, in the field of the nuclear industry, or in the aviation or space industry.

### BACKGROUND OF THE DISCLOSURE

In applications such as the characterization of devices subjected to radioactive sources, or the characterization of the aging ability of devices used in particularly harsh environments, for example in aircrafts or spacecrafts, elemental analysis of metal samples could prove to be essential.

More specifically, it may prove necessary to be able to map these elements within the analyzed sample. Mapping means an identification of the elements making up the sample analyzed and, optionally, the distribution and the bond between the various elements.

Such an analysis could prove particularly useful in studies of metal embrittlement by hydrogen, or in studies of aging of fuel cladding in the presence of oxygen, or in studies of embrittlement of fuel cladding caused by the formation of hydrides, these promoting the propagation of cracks.

There are various known methods of mapping elements present in samples.

One of these methods is elemental analysis by optical emission spectrometry on laser-produced plasma, a technique practiced in a natural atmosphere, also referred to by the English acronym “LIBS” corresponding to the English expression “laser induced breakdown spectroscopy”.

This method applies in particular to the in situ inspection and characterization of samples of parts to be analyzed.

A method and a device for elemental analysis by optical emission spectrometry on laser-produced plasma in the presence of argon is described by the patent document published under number EP 0,654,663.

Conventionally, an analysis device comprises a frame on which are mounted:
a module for generating a laser beam,
a module for shaping the beam integrating at least one lens and a diaphragm for selecting a portion of the laser beam emitted by the generation module,
optical means for focusing the laser beam on a sample to be studied, and,
means of collecting the optical emission.

After shaping by the shaping module, the laser beam generated by the generation module is applied on a sample to be studied via the focusing optical means.

A plasma is then created at the impact of the laser beam on the sample to be studied, the plasma generating an optical emission to be analyzed to map the elements composing the studied sample.

The collection of the optical emission of the plasma is carried out by the collection means.

To this end, the collection means comprise an optical fiber a free end of which is brought the closest to the plasma. The closer the free end of the fiber is to the plasma, the more light noise is eliminated. In other words, the closer the optical fiber is to the plasma, the less ambient light is captured by the plasma. Hence, the analysis of the light captured by the optical fiber is of better quality than when the optical fiber is away from the plasma.

More specifically, the free end of the optical fiber has an end section transverse to the direction of extension of the fiber, through which the optical emission of the plasma is collected.

To obtain quality collection, the optical fiber must be positioned so that its section forms an angle of about 60° with the direction of projection of the laser beam.

Once collected, the optical emission is analyzed by determination means to which the optical fiber is connected.

Nonetheless, the use of an optical fiber has a major drawback.

Indeed, since the optical fiber is made of silica, it cannot be bent. Consequently, the collection means occupy a considerable volume in the analysis device.

Moreover, the angle formed with the laser beam is large since it allows the best possible collection of the optical emission, thanks to the optimum positioning of the end section of the optical fiber, without any risk of obscuring the laser beam, which allows obtaining an optimum quality of the plasma generated by the reaction between the laser beam and the sample to be studied.

This then increases the total footprint of the collection means and therefore of the analysis device.

More specifically, this angle is determined so that:
the collection means, in particular the optical fiber, do not come into contact with lenses of the device, i.e. optical means for focusing the laser beam, and
the optical fiber is not in contact with the surface of the sample to be analyzed and even too close to the generated plasma, as this might destroy the fiber.

### SUMMARY

In particular, an objective of the invention is to overcome the drawbacks of the prior art.

More specifically, an objective of the invention is to provide collection means allowing ensuring the collection of the optical emission of a plasma while having a reduced footprint or, more generally, a spatial positioning optimized with regards to the space available around the sample to be analyzed.

Another objective of the invention is to provide such collection means which offer an optimum quality of the collected optical emission.

A further objective of the invention is to provide such collection means which are simple to implement and install.

These objectives, as well as others that will appear later on, are achieved thanks to the invention which relates to a device for elemental analysis of a sample to be studied, comprising a frame on which are mounted:
a stand intended to support a sample to be studied;
a module for generating a laser beam intended to impact a sample to be studied in a direction perpendicular to the stand, to generate a plasma generating an optical emission, and
means for collecting the optical emission, comprising an optical fiber having a free end defining an end portion to be placed proximate to the plasma,
   characterized in that the end portion of the optical fiber of the collection means extends along a main axis forming with the stand an angle A strictly smaller than 30°, and in that the free end has a bevel cutout defining the end section.

Thanks to the bevel cutout, it is possible to reduce the angle of the optical fiber with respect to the stand.

This directly benefits the compactness of the analysis device.

Moreover, by reducing the angle between the optical fiber and the stand, the end section of the optical fiber can be brought the closest to the plasma, which benefits the quality of the analysis since the distance between the optical emission and the end section is minimum.

Furthermore, the bevel offers good capture and good propagation of the light flux throughout the optical fiber.

According to an advantageous aspect, the end section is oriented in the direction of an upper portion of the plasma.

However, tests have demonstrated that orienting the end section in the direction of the upper portion of the plasma offers a higher quality of analysis than conventional solutions.

According to another advantageous aspect, the optical fiber has a diameter of 1,000 μm.

This optical fiber diameter ensures sufficient optical emission collection to enable elemental mapping of the composition of the sample studied and allows making the bevel cutout easily.

The invention also relates to a method for elemental analysis of a sample, characterized in that the method implements an analysis device as described before.

### BRIEF DESCRIPTION OF THE DRAWINGS

Other features and advantages of the invention will appear more clearly upon reading the following description of a preferred embodiment of the invention, given as an illustrative and non-limiting example, and from the appended drawings described hereinafter.

FIG. 1 is a schematic representation of an analysis system comprising an analysis device according to the invention.

FIG. 2 is a detailed schematic representation of the analysis device according to the invention, illustrating means for collecting an optical emission of plasma.

FIG. 3 is a detailed schematic representation of a free end of an optical fiber of the collection means of the analysis device according to the invention.

FIG. 4 is a detailed schematic representation of an analysis device, illustrating means for collecting an optical emission of plasma, according to the prior art.

FIG. 5 is a detailed schematic representation of a free end of an optical fiber of the collection means of the analysis device according to a variant of the invention.

### DETAILED DESCRIPTION

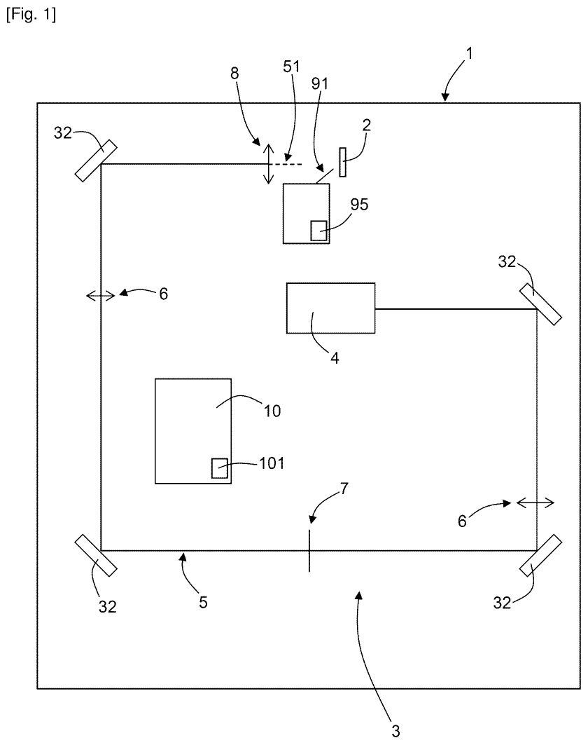

FIG. 1 illustrates a system 1 for elemental analysis of a sample 2 to be studied.

The system 1 includes an analysis device 3 as described hereinafter, this analysis device 3 comprising a stand 31 for receiving the sample 2.

The analysis device 3 also comprises a frame on which are mounted:
a module 4 for generating a laser beam 5,
a module for shaping the laser beam 5 integrating at least one lens 6 and a diaphragm 701, 702, 703 for selecting a portion of the laser beam 5 emitted by the generation module 4,
optical means 8 for focusing the laser beam 5 on the sample 2 to be studied.

As illustrated by FIG. 1, the analysis device 3 comprises, along the direction of emission of the laser beam 5 from the generation module 4 towards the sample 2, a plurality of lenses 6 and a diaphragm 7.

The analysis device 3 also comprises a plurality of mirrors 32 allowing deflecting the laser beam 5 from the generation module 4 up to the focusing means 8, in order to limit the footprint of the analysis device 3.

At the output of the focusing optical means 8, the laser beam 5 becomes a focusing beam 51. In this case, the focusing beam 51 has a conical shape which becomes progressively thinner in the direction of the sample 2, whereas between the generation module 4 and the focusing means 8, the laser beam 5 has a substantially cylindrical shape.

Furthermore, the system 1 comprises collection means 9 and determination means 10 the role of which will be described hereinafter.

As described before, the system 1 allows analyzing a sample 2 to map its elemental composition.

To this end, the laser beam 5 is emitted by the generation module 4 so as to be directed towards the sample 2 to impact its surface.

When the laser beam 5 impacts the sample 2 to be studied, a plasma P is created, generating an optical emission to be analyzed to map the elements composing the sample 2.

The collection of the optical emission of the plasma is carried out by the collection means 9.

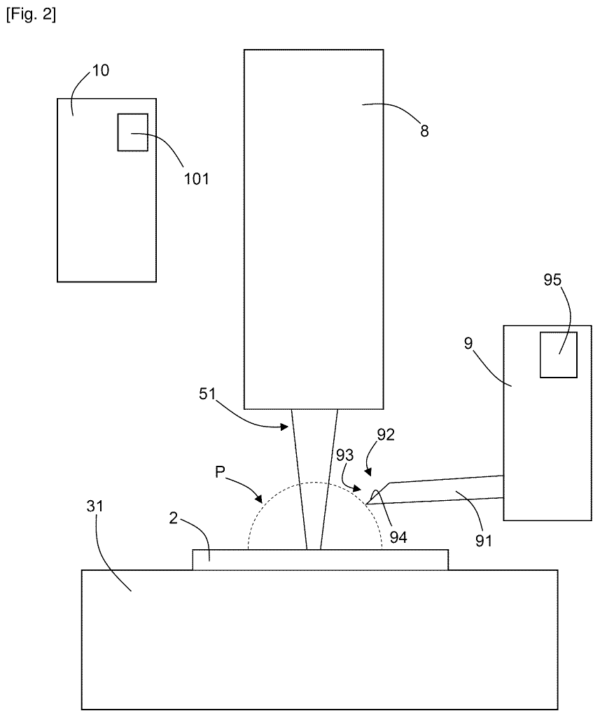

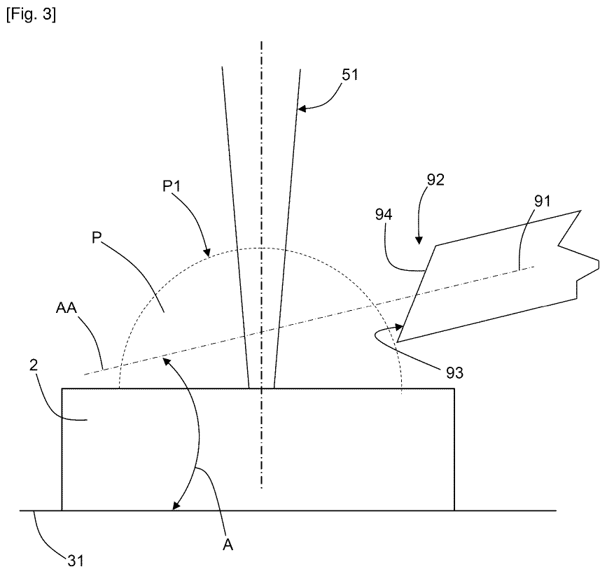

For this purpose, as illustrated by FIGS. 2 and 3, the collection means 9 comprise an optical fiber 91 a free end of which defining an end portion 92 is brought the closest to the plasma P. Preferably, the optical fiber 91 has a diameter of 1,000 μm.

The end portion 92 extends along a main axis AA forming with the stand 31 an angle A strictly smaller than 30°.

The end portion 92 has an end section 93 which is positioned the closest to the plasma P.

According to the embodiment illustrated by FIGS. 2 and 3, the end portion 92 has a bevel cutout 94 defining the end section 93.

The end section 93 is oriented upwards, in the direction opposite to the plasma P.

In other words, the end section 93 is oriented in the direction of an upper portion P1 of the plasma P. The upper portion P1 is distant from the impact area between the laser beam 5 and the sample 2, in the direction of the focusing optical means 8.

The collection means 9 also comprise first communication means 95 intended to establish, together with second communication means 101 of the determination means 10, a communication path.

The first communication means 95 and the second communication means 101 may be of the wireless type. Alternatively, the first communication means 95 and the second communication means 101 may be in the form of connectors intended to receive the plug of a wired connection cable.

This allows protecting the optical fiber 91 to ensure that the collection of the optical emission is carried out in an optimum manner.

Furthermore, the needle allows maintaining the position of the end section 93 facing and as close as possible to the plasma P.

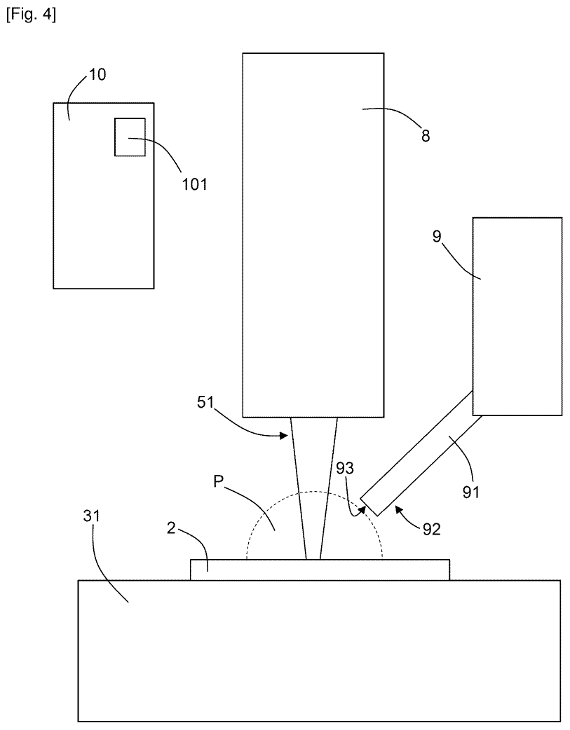

With reference to FIG. 4, which schematically shows an analysis device 3 according to the prior art, one could notice the reduction in space obtained by the use of collection means 9 according to the invention, as well as the gain in collection quality.

Indeed, by reducing the angle A, it is possible to free up a significant space above the collection means 9. Thus, this could allow accommodating other equipment of the analysis device 3, and/or reducing the size of a protective casing of the analysis device 3.

Furthermore, as one could notice between FIGS. 2 and 3 on the one hand, and FIG. 4 on the other hand, thanks to the bevel cutout 94, the end section 93 can be brought the closest to the plasma P.

In addition, the bevel cutout 94 allows obtaining an end section 93 having a larger surface area in comparison with the end section 93 of the prior art. As a result, the optical fiber 91 of the collection means 9 of the analysis device 3 according to the invention can capture a greater light intensity of the plasma P, to the benefit of the quality of the analysis carried out by the determination means 10.

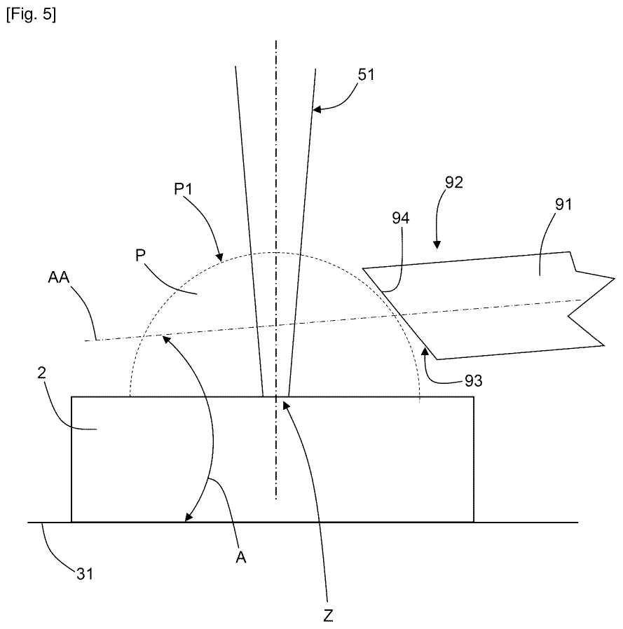

According to a variant illustrated by FIG. 5, the end section 93 is oriented in the direction of the plasma P. More specifically, the end section 93 is oriented towards an area of impact of the laser beam 5 on the sample 2.

More specifically, the end section 93 is directed towards the sample 2 and the support 31.

This particular orientation allows preserving a substantial capture of the light intensity emitted by the plasma P.

Although the present disclosure has been described with reference to one or more examples, workers skilled in the art will recognize that changes may be made in form and detail without departing from the scope of the disclosure and/or the appended claims.

1. A device for elemental analysis of a sample to be studied, the device comprising:
a frame on which are mounted:
a stand to support the sample to be studied;
a laser source to generate a laser beam to impact the sample to be studied in a direction perpendicular to the stand, to generate a plasma generating an optical emission; and
an optical collector to collect the optical emission, comprising an optical fiber having a free end defining an end portion having an end section to be placed proximate to the plasma, wherein the end portion of the optical fiber extends along a main axis forming with the stand an angle strictly smaller than 30°, and wherein the free end has a bevel cutout defining the end section.

2. The device according to claim 1, wherein the end section is oriented upwards.

3. The analysis device according to claim 1, wherein the optical fiber has a diameter of 1,000 μm.

4. A method comprising:
performing an elemental analysis of a sample, using an analysis device comprising:
a frame on which are mounted:
a stand to support the sample to be studied;
a laser source; and
an optical collector comprising an optical fiber having a free end defining an end portion having an end section, wherein the end portion of the optical fiber extends along a main axis forming with the stand an angle strictly smaller than 30°, and wherein the free end has a bevel cutout defining the end section
wherein the performing comprises:
supporting the sample on the stand;
generating a laser beam with the laser source to impact the sample to be studied in a direction perpendicular to the stand, to generate a plasma generating an optical emission; and
collecting the optical emission with the optical collector, wherein the end section is placed proximate to the plasma.
